(19) United States
(12) Patent Application Publication
(10) Pub. No.: US 2025/0223142 A1
(43) Pub. Date: Jul. 10, 2025

(54) LANE GRID SETUP FOR AUTONOMOUS MOBILE ROBOT

(71) Applicant: Seegrid Corporation, Pittsburgh, PA (US)

(72) Inventors: Tri-An Le, Pittsburgh, PA (US); Nicholas Alan Melchior, Pittsburgh, PA (US); Katherine Crawford, Pittsburgh, PA (US); Jada Gerz, Pittsburgh, PA (US); Isaac Buckman, Aliquippa, PA (US); Andy Christman, Pittsburgh, PA (US); Jesse Legg, Pittsburgh, PA (US); Brian Dunlavey, Pittsburgh, PA (US); Bobbi Jamriska, McDonald, PA (US); Ryan Young, Newtown, PA (US)

(21) Appl. No.: 18/849,310

(22) PCT Filed: Jun. 5, 2023
(86) PCT No.: PCT/US2023/024411

§ 371 Date: Sep. 20, 2024

Related U.S. Application Data
(60) Provisional application No. 63/348,542, filed on Jun. 3, 2022.

(51) Int. Cl. B66F 9/06; G05D 1/224; G05D 109/10

(52) U.S. Cl. CPC B66F 9/063; G05D 1/2246; G05D 2109/10

(57) ABSTRACT

A system, comprising at least one autonomous mobile robot (AMR); a lane grid generation system configured to generate a lane grid including route segments of the at least one AMR comprising computer program code executable by at least one processor to: drive the AMR in a first direction to demonstrate a route in a second direction opposite the first direction of the at least one AMR during an autonomous mode of the AMR; and determine a plurality of lanes for the AMR to provide loads within a full range of each of the plurality of lanes; and a navigation system configured to direct the movement of the at least one AMR based on the route segments.

### CROSS REFERENCE TO RELATED APPLICATIONS

This application claims the benefit of priority from U.S. Provisional Patent Appl. 63/348,542, filed on Jun. 3, 2022, entitled Lane Grid Setup for Autonomous Mobile Robot, the contents of which are incorporated herein by reference.

The present application may be related to International Application No. PCT/US23/24114 filed on Jun. 1, 2023, entitled System and Method for Generating Complex Runtime Path Networks From Incomplete Demonstration of Trained Activities, which claimed the benefit of priority from U.S. Provisional Patent Appl. 63/348,520, filed on Jun. 3, 2022, entitled System and Method for Generating Complex Runtime Path Networks from Incomplete Demonstration of Trained Activities, each of which is incorporated herein by reference.

The present application may be related to International Application No. PCT/US23/23699 filed on May 26, 2023, entitled System and Method for Performing Interactions with Physical Objects Based on Fusion of Multiple Sensors, which claimed the benefit of priority from U.S. Provisional Patent Appl. 63/346,483, filed on May 27, 2022, entitled System and Method for Performing Interactions with Physical Objects Based on Fusion of Multiple Sensors, each of which is incorporated herein by reference.

The present application may be related to International Application No. PCT/US23/016556 filed on Mar. 28, 2023, entitled A Hybrid, Context-Aware Localization System For Ground Vehicles; International Application No. PCT/US23/016565 filed on Mar. 28, 2023, entitled Safety Field Switching Based On End Effector Conditions In Vehicles; International Application No. PCT/US23/016608 filed on Mar. 28, 2023, entitled Dense Data Registration From An Actuatable Vehicle-Mounted Sensor; International Application No. PCT/U.S. Pat. No. 23,016,589, filed on Mar. 28, 2023, entitled Extrinsic Calibration Of A Vehicle-Mounted Sensor Using Natural Vehicle Features; International Application No. PCT/US23/016615, filed on Mar. 28, 2023, entitled Continuous And Discrete Estimation Of Payload Engagement/Disengagement Sensing; International Application No. PCT/US23/016617, filed on Mar. 28, 2023, entitled Passively Actuated Sensor System; International Application No. PCT/US23/016643, filed on Mar. 28, 2023, entitled Automated Identification Of Potential Obstructions In A Targeted Drop Zone; International Application No. PCT/US23/016641, filed on Mar. 28, 2023, entitled Localization of Horizontal Infrastructure Using Point Clouds; International Application No. PCT/US23/016591, filed on Mar. 28, 2023, entitled Robotic Vehicle Navigation With Dynamic Path Adjusting; International Application No. PCT/US23/016612, filed on Mar. 28, 2023, entitled Segmentation of Detected Objects Into Obstructions and Allowed Objects; International Application No. PCT/US23/016554, filed on Mar. 28, 2023, entitled Validating the Pose of a Robotic Vehicle That Allows It To Interact With An Object On Fixed Infrastructure; and International Application No. PCT/US23/016551, filed on Mar. 28, 2023, entitled A System for AMRs That Leverages Priors When Localizing and Manipulating Industrial Infrastructure, the contents of which is incorporated herein by reference.

The present application may be related to U.S. Provisional Appl. 63/430,184 filed on Dec. 5, 2022, entitled Just in Time Destination Definition and Route Planning; U.S. Provisional Appl. 63/430,190 filed on Dec. 5, 2022, entitled Configuring a System that Handles Uncertainty with Human and Logic Collaboration in a Material Flow Automation Solution; U.S. Provisional Appl. 63/430,182 filed on Dec. 5, 2022, entitled Composable Patterns of Material Flow Logic for the Automation of Movement; U.S. Provisional Appl. 63/430,174 filed on Dec. 5, 2022, entitled Process Centric User Configurable Step Framework for Composing Material Flow Automation; U.S. Provisional Appl. 63/430,195 filed on Dec. 5, 2022, entitled Generation of “Plain Language” Descriptions Summary of Automation Logic; U.S. Provisional Appl. 63/430,171 filed on Dec. 5, 2022, entitled Hybrid Autonomous System Enabling and Tracking Human Integration into Automated Material Flow; US Provisional Appl. 63/430, 180 filed on Dec. 5, 2022, entitled A System for Process Flow Templating and Duplication of Tasks Within Material Flow Automation; U.S. Provisional Appl. 63/430,200 filed on Dec. 5, 2022, entitled A Method for Abstracting Integrations Between Industrial Controls and Autonomous Mobile Robots (AMRs); and U.S. Provisional Appl. 63/430,170 filed on Dec. 5, 2022, entitled Visualization of Physical Space Robot Queuing Areas as Non Work Locations for Robotic Operations, each of which is incorporated herein by reference in its entirety.

The present application may be related to U.S. Provisional Appl. 63/410,355 filed on Sep. 27, 2022, entitled Dynamic, Deadlock-Free Hierarchical Spatial Mutexes Based on a Graph Network; U.S. Provisional Appl. 63/423,679, filed Nov. 8, 2022, entitled System and Method for Definition of a Zone of Dynamic Behavior with a Continuum of Possible Actions and Structural Locations within Same; U.S. Provisional Appl. 63/423,683, filed Nov. 8, 2022, entitled System and Method for Optimized Traffic Flow Through Intersections with Conditional Convoying Based on Path Network Analysis; and U.S. Provisional Appl. 63/423,538, filed Nov. 8, 2022, entitled Method for Calibrating Planar Light-Curtain; each of which is incorporated herein by reference in its entirety.

The present application may be related to US Provisional Appl. 63/324, 182 filed on Mar. 28, 2022, entitled A Hybrid, Context-aware Localization System for Ground Vehicles; U.S. Provisional Appl. 63/324,184 filed on Mar. 28, 2022, entitled Safety Field Switching Based On End Effector Conditions; US Provisional Appl. 63/324, 185 filed on Mar. 28, 2022, entitled Dense Data Registration From a Vehicle Mounted Sensor Via Existing Actuator; U.S. Provisional Appl. 63/324,187 filed on Mar. 28, 2022, entitled Extrinsic Calibration Of A Vehicle-Mounted Sensor Using Natural Vehicle Features; U.S. Provisional Appl. 63/324,188 filed on Mar. 28, 2022, entitled Continuous And Discrete Estimation Of Payload Engagement/Disengagement Sensing; U.S. Provisional Appl. 63/324,190 filed on Mar. 28, 2022, entitled Passively Actuated Sensor Deployment; U.S. Provisional Appl. 63/324,192 filed on Mar. 28, 2022, entitled Automated Identification Of Potential Obstructions In A Targeted Drop Zone; US Provisional Appl. 63/324, 193 filed on Mar. 28, 2022, entitled Localization Of Horizontal Infrastructure Using Point Clouds; U.S. Provisional Appl. 63/324,195 filed on Mar. 28, 2022, entitled Navigation Through Fusion of Multiple Localization Mechanisms and Fluid Transition Between Multiple Navigation Methods; U.S. Provisional Appl. 63/324,198 filed on Mar. 28, 2022, entitled Segmentation Of Detected Objects Into Obstructions And Allowed Objects; U.S. Provisional Appl. 63/324,199 filed on Mar. 28, 2022, entitled Validating The Pose Of An AMR That Allows It To Interact With An Object; and U.S. Provisional Appl. 63/324,201 filed on Mar. 28, 2022, entitled A System For AMRs That Leverages Priors When Localizing Industrial Infrastructure; each of which is incorporated herein by reference in its entirety.

The present application may be related to U.S. patent application Ser. No. 11/350,195, filed on Feb. 8, 2006, U.S. Pat. No. 7,446,766, Issued on Nov. 4, 2008, entitled Multidimensional Evidence Grids and System and Methods for Applying Same; U.S. patent application Ser. No. 12/263,983 filed on Nov. 3, 2008, U.S. Pat. No. 8,427,472, Issued on Apr. 23, 2013, entitled Multidimensional Evidence Grids and System and Methods for Applying Same; U.S. patent application Ser. No. 11/760,859, filed on Jun. 11, 2007, U.S. Pat. No. 7,880,637, Issued on Feb. 1, 2011, entitled Low-Profile Signal Device and Method For Providing Color-Coded Signals; U.S. patent application Ser. No. 12/361,300 filed on Jan. 28, 2009, U.S. Pat. No. 8,892,256, Issued on Nov. 18, 2014, entitled Methods For Real-Time and Near-Real Time Interactions With Robots That Service A Facility; U.S. patent application Ser. No. 12/361,441, filed on Jan. 28, 2009, U.S. Pat. No. 8,838,268, Issued on Sep. 16, 2014, entitled Service Robot And Method Of Operating Same; U.S. patent application Ser. No. 14/487,860, filed on Sep. 16, 2014, U.S. Pat. No. 9,603,499, Issued on Mar. 28, 2017, entitled Service Robot And Method Of Operating Same; U.S. patent application Ser. No. 12/361,379, filed on Jan. 28, 2009, U.S. Pat. No. 8,433,442, Issued on Apr. 30, 2013, entitled Methods For Repurposing Temporal-Spatial Information Collected By Service Robots; U.S. patent application Ser. No. 12/371,281, filed on Feb. 13, 2009, U.S. Pat. No. 8,755,936, Issued on Jun. 17, 2014, entitled Distributed Multi-Robot System; U.S. patent application Ser. No. 12/542,279, filed on Aug. 17, 2009, U.S. Pat. No. 8,169,596, Issued on May 1, 2012, entitled System And Method Using A Multi-Plane Curtain; U.S. patent application Ser. No. 13/460,096, filed on Apr. 30, 2012, U.S. Pat. No. 9,310,608, Issued on Apr. 12, 2016, entitled System And Method Using A Multi-Plane Curtain; U.S. patent application Ser. No. 15/096,748, filed on Apr. 12, 2016, U.S. Pat. No. 9,910,137, Issued on Mar. 6, 2018, entitled System and Method Using A Multi-Plane Curtain; U.S. patent application Ser. No. 13/530,876, filed on Jun. 22, 2012, U.S. Pat. No. 8,892,241, Issued on Nov. 18, 2014, entitled Robot-Enabled Case Picking; U.S. patent application Ser. No. 14/543,241, filed on Nov. 17, 2014, U.S. Pat. No. 9,592,961, Issued on Mar. 14, 2017, entitled Robot-Enabled Case Picking; U.S. patent application Ser. No. 13/168,639, filed on Jun. 24, 2011, U.S. Pat. No. 8,864,164, Issued on Oct. 21, 2014, entitled Tugger Attachment; US Design patent application Ser. No. 29/398,127, filed on Jul. 26, 2011, US Patent Number D680,142, Issued on Apr. 16, 2013, entitled Multi-Camera Head; US Design patent application Ser. No. 29/471,328, filed on Oct. 30, 2013, US Patent Number D730,847, Issued on Jun. 2, 2015, entitled Vehicle Interface Module; US Patent Appl. 14/196, 147, filed on Mar. 4, 2014, U.S. Pat. No. 9,965,856, Issued on May 8, 2018, entitled Ranging Cameras Using A Common Substrate; U.S. patent application Ser. No. 16/103,389, filed on Aug. 14, 2018, U.S. Pat. No. 11,292,498, Issued on Apr. 5, 2022, entitled Laterally Operating Payload Handling Device; U.S. patent application Ser. No. 16/892,549, filed on Jun. 4, 2020, US Publication Number 2020/0387154, Published on Dec. 10, 2020, entitled Dynamic Allocation And Coordination of Auto-Navigating Vehicles and Selectors; U.S. patent application Ser. No. 17/163,973, filed on Feb. 1, 2021, US Publication Number 2021/0237596, Published on Aug. 5, 2021, entitled Vehicle Auto-Charging System and Method, U.S. patent application Ser. No. 17/197,516, filed on Mar. 10, 2021, US Publication Number 2021/0284198, Published on Sep. 16, 2021, entitled Self-Driving Vehicle Path Adaptation System and Method; U.S. patent application Ser. No. 17/490,345, filed on Sep. 30, 2021, US Publication Number 2022-0100195, published on Mar. 31, 2022, entitled Vehicle Object-Engagement Scanning System And Method; U.S. patent application Ser. No. 17/478,338, filed on Sep. 17, 2021, US Publication Number 2022-0088980, published on Mar. 24, 2022, entitled Mechanically-Adaptable Hitch Guide each of which is incorporated herein by reference in its entirety.

### FIELD OF INTEREST

The present inventive concepts relate to systems and methods in the field of autonomous and/or robotic vehicles. In particular, the inventive concepts may be related to systems and methods in the field of generating lane grids, which can be implemented by or in an autonomous mobile robot (AMR).

### BACKGROUND

Floor buffer spaces that require lanes are common in material handling environments. Setup for robots to build and deplete these lanes of materials involves complex maneuvering and precision that are hard to scale when manual setup is involved. It is also difficult to set up the lanes in a way that does not require even more precise material placement within the lanes after implementation. Current solutions with precise AMRs lack the flexibility needed for optimal lane operations.

Training by demonstration is an effective way to teach robots to perform tasks, such as navigation, in a predictable manner. Typical training involves a user navigating the AMR through an environment to learn routes within a facility layout. Subsequently, in use, the AMR can navigate itself along the learned routes in a manner that mimics its translation during the training exercise.

Routes within the environment can be logically represented as a series of route segments. An AMR can navigate a plurality of route segments to navigate a route that can comprise one or more stops for load pick up and/or drop off. Currently, in creating a network of mobile robot route segments, a large number of route segments must be demonstrated with significant duplication and precise coordination.

### SUMMARY OF THE INVENTION

The inventive concepts relate to a system and method of lane grid generation and/or setup for autonomous mobile robots (AMRs) to use during autonomous navigation.

In accordance with one aspect of the inventive concepts, provided is a route generation system, comprising a computer program code stored in a computer storage media in communication with at least one processor and executable by the at least one processor to: generate route information based on sensor data, a travel path, and a direction travelled by an AMR during a training run; build an AMR route based on the route information, the AMR route comprising a network of route segments, including at least one route segment to be travelled in a second direction different than a first direction that the route segment was travelled during the training run; and store the AMR route for autonomous navigation use by the AMR.

In various embodiments, the network of route segments comprises overlapping route segments and behaviors that execute spatial mutexes to avoid simultaneous occupancy by multiple AMRs of the overlapping route segments.

In various embodiments, the second direction is opposite the first direction.

In various embodiments, the at least one sensor includes at least one laser imaging, detection, and ranging (LiDAR) and/or at least one stereo camera.

In various embodiments, the system is further configured to generate the AMR route to include one or more lane grids comprising a plurality of lanes, each lane providing a selectable option for the AMR during navigation based, at least in part, on real-time sensor data collected by the AMR.

In various embodiments, the plurality of lanes of a lane grid from the one or more lane grids includes: at least one lane defining a plurality of pick and/or drop locations where a load can be flexibly picked and/or dropped in one of the pick and/or drop locations based, at least in part, on real-time sensor data collected by the AMR.

In various embodiments, the load comprises at least one pallet.

In various embodiments, a lane grid defines a range of adjacent lanes as linear spaces, each linear space comprising the plurality of pick and/or drop locations.

In various embodiments, a lane grid is generated and stored as a composite logic entity made of route segments comprising stations, routes, and/or zones.

In various embodiments, each lane of a lane grid is stored and individually accessible as a lane grid object.

In various embodiments, the lane grid object comprises a plurality of layers, each layer comprising a lane of the lane grid object.

In various embodiments, the system is further configured to generate a lane grid to include layered intersection zones having a plurality of route segments defining a plurality of travel paths through an intersection that enable the AMR to travel along a first path while at least one other AMR travels along a second path through the intersection.

In various embodiments, the lane grid is stored as a lane grid object that comprises a plurality of layers, each layer comprising a travel path through the intersection.

In various embodiments, system further comprises a user interface (UI) module configured to generate step-by-step user instructions via an interactive UI device that enable generation of at least one lane grid from the one or more lane grids in response to user inputs via the UI device.

In various embodiments, the user interface (UI) module is configured to generate one or more screens that enable a user to graphically train one or more route segments and/or lane grids.

In various embodiments, the user interface (UI) module is configured to generate one or more screens that enable a user to graphically train one or more route segments to be travelled in a direction different than a direction used to train the one or more route segments.

In various embodiments, the user interface (UI) module is configured to graphically build the AMR route as a combination of route information and/or route segments from a training run and one or more logic grids trained via the UI module.

In various embodiments, system further comprises a navigation system configured to autonomously navigate the AMR using the AMR route, including selectively executing a route segment from among a plurality of route segments of a lane grid based, at least in part, on real-time sensor data.

In accordance with another aspect of the inventive concepts, provided is a route generation method, comprising generating route information based on sensor data, a travel path, and a direction travelled by an AMR during a training run; building an AMR route based on the route information, the AMR route comprising a network of route segments, including at least one route segment to be travelled in a second direction different than a first direction that the route segment was travelled during the training run; and storing the AMR route for autonomous navigation use by the AMR.

In various embodiments, the network of route segments comprises overlapping route segments and behaviors that execute spatial mutexes to avoid simultaneous occupancy by multiple AMRs of the overlapping route segments.

In various embodiments, the second direction is opposite the first direction.

In various embodiments, the at least one sensor includes at least one laser imaging, detection, and ranging (LiDAR) and/or at least one stereo camera.

In various embodiments, the method further comprises generating the AMR route to include one or more lane grids comprising a plurality of lanes, each lane providing a selectable option for the AMR during navigation based, at least in part, on real-time sensor data collected by the AMR.

In various embodiments, the plurality of lanes of a lane grid includes at least one lane defining a plurality of pick and/or drop locations where a load can be flexibly picked and/or dropped in one of the plurality of pick and/or drop locations based, at least in part, on real-time sensor data collected by the AMR.

In various embodiments, the load comprises at least one pallet.

In various embodiments, the method further comprises generating a lane grid defining a range of adjacent lanes as linear spaces, each linear space comprising the plurality of pick and/or drop locations.

In various embodiments, the method further comprises generating and storing a lane grid as a composite logic entity made of route segments comprising stations, routes, and/or zones.

In various embodiments, the method further comprises generating and storing a lane grid as an individually accessible lane grid object.

In various embodiments, the method further comprises generating and storing a lane grid object to include a plurality of layers, each layer comprising a lane of the lane grid object.

In various embodiments, the method further comprises generating a lane grid to include layered intersection zones having a plurality of route segments defining a plurality of travel paths through an intersection that enable the AMR to travel along a first path while at least one other AMR travels along a second path through the intersection.

In various embodiments, the method further comprises storing the lane grid as a lane grid object that comprises a plurality of layers, each layer comprising a travel path through the intersection.

In various embodiments, the method further comprises generating step-by-step user instructions via an interactive user interface (UI) device and that enable generating at least one lane grid from the one or more lane grids in response to user inputs via the UI device.

In various embodiments, the method further comprises generating via the user interface (UI) device one or more screens enabling a user to graphically train one or more route segments and/or lane grids.

In various embodiments, the method further comprises generating via the user interface (UI) device one or more screens enabling a user to graphically train one or more route segments to be travelled in a direction different than a direction used to train the one or more route segments.

In various embodiments, the method further comprises generating screen at the user interface (UI) device enabling graphically building the AMR route as a combination of route information and/or route segments from a training run and one or more logic grids trained via the UI module.

In various embodiments, the method further comprises autonomously navigating the AMR using the AMR route, including selectively executing a route segment from among a plurality of route segments of a lane grid based, at least in part, on real-time sensor data.

In accordance with another aspect of the inventive concepts, provided is an autonomous mobile robot (AMR) route generation system, comprising: at least one processor and computer memory; and a route generation program code executable by at least one processor to: process sensor data collected by at least one sensor while an AMR is driven in a first direction along a path; generate route information based on the sensor data and the path; generate one or more lane grids comprising a plurality of lanes, each lane providing a navigation option for the AMR based, at least in part, on real-time sensor data collected by the AMR; and generate an AMR route as a network of route segments comprising at least some of the route information and the one or more lane grids, wherein the AMR route is executable by the AMR to autonomously navigate in a second direction that is different from the first direction for one or more portions of the AMR route.

In various embodiments, the system can include or be combined with any other feature or combinations disclosed herein.

In accordance with another aspect of the inventive concepts, provided is an autonomous mobile robot (AMR) route generation method executable by at least one processor, the method comprising: providing at least one processor and computer memory; and executing a route generation program code by at least one processor, including: processing sensor data collected by at least one sensor while an AMR is driven in a first direction along a path; generating route information based on the sensor data and the path; generating one or more lane grids comprising a plurality of lanes, each lane providing a navigation option for the AMR based, at least in part, on real-time sensor data collected by the AMR; and generating an AMR route as a network of route segments comprising at least some of the route information and the one or more lane grids, wherein the AMR route is executable by the AMR to autonomously navigate in a second direction that is different from the first direction for one or more portions of the AMR route.

In various embodiments, the method can include or be combined with any other feature or combinations disclosed herein.

In accordance with another aspect of the inventive concepts, provided is an autonomous mobile robot (AMR), comprising: at least one sensor, a navigation system, and at least one processor and computer memory; and an information processing system comprising computer program code executable by at least one processor to: process sensor data collected by the at least one sensor while the AMR is driven in a first direction along a path; generate route information based on the sensor data and the path; generate one or more lane grids comprising a plurality of lanes, each lane providing a navigation option for the AMR based, at least in part, on real-time sensor data collected by the AMR; and generate an AMR route as a network of route segments comprising at least some of the route information and the one or more lane grids, wherein the AMR route is executable by the AMR to autonomously navigate in a second direction that is different from the first direction for one or more portions of the AMR route.

In various embodiments, the AMR can include or be combined with any other feature or combinations disclosed herein.

In accordance with another aspect of the inventive concepts, provided is a method of navigating an autonomous mobile robot (AMR), comprising: initiating autonomous navigation using an AMR route, the AMR route including at least one lane grid comprising a plurality of lanes, each lane providing a navigation option for the AMR based, at least in part, on real-time sensor data collected by the AMR; and collecting sensor data using one or more sensors while executing the AMR route; executing a lane grid when the AMR reaches a lane grid, including, selecting a lane from the lane grid for navigation based, at least in part, on real-time sensor data from the one or more sensors; selecting a location from a plurality of locations within the selected lane to perform an AMR behavior.

In various embodiments, the method can include or be combined with any other feature or combinations disclosed herein.

In accordance with another aspect of the inventive concepts, provided is a lane grid generation system, comprising: at least one processor and computer memory; and a route generation program code executable by at least one processor to: generate one or more lane grids comprising a plurality of lanes, each lane providing an option for navigation during autonomous AMR navigation; and store the lane grid for use in at least one AMR route.

In various embodiments, the route generation program code is further executable to store the lane grid as a single object in an object-oriented program (OOP) environment.

In various embodiments, a lane grid comprises a reference to each lane in the plurality of lanes that is selectable for navigation by an AMR executing the lane grid.

In various embodiments, the plurality of lanes includes at least one lane that is a linear area.

In various embodiments, the plurality of lanes includes at least one lane having a plurality of drop and/or pick locations.

In various embodiments, the lane grid represents an intersection and the plurality of lanes includes a plurality of travel paths through the intersection.

In various embodiments, the lane grid represents an intersection and the plurality of lanes includes a plurality of individually selectable travel paths through the intersection.

In various embodiments, the system can include or be combined with any other feature or combinations disclosed herein.

In accordance with another aspect of the inventive concepts, provided is a system configured to generate a route for navigating an autonomous mobile robot (AMR) as shown and described.

In accordance with another aspect of the inventive concepts, provided is a system configured to train a route of an autonomous mobile robot (AMR) as shown and described.

In accordance with another aspect of the inventive concepts, provided is a method of generating a route for navigating an autonomous mobile robot (AMR) as shown and described.

In accordance with another aspect of the inventive concepts, provided is a method of training a route of an autonomous mobile robot (AMR) as shown and described.

In accordance with another aspect of the inventive concepts, provided is an autonomous mobile robot as shown and described.

Those skilled in the art will appreciate that the above stated features can be combined in a variety of manners without departing from the inventive concepts.

### BRIEF DESCRIPTION OF THE DRAWINGS

The present invention will become more apparent in view of the attached drawings and accompanying detailed description. The embodiments depicted therein are provided by way of example, not by way of limitation, wherein like reference numerals refer to the same or similar elements. In the drawings:

FIG. 1A provides a perspective view of a robotic vehicle in accordance with aspects of the inventive concepts.

FIG. 1B provides a side view of a robotic vehicle with its load engagement portion retracted, in accordance with aspects of the inventive concepts.

FIG. 1C provides a side view of a robotic vehicle with its load engagement portion extended, in accordance with aspects of the inventive concepts.

FIG. 1D provides another perspective view of a robotic vehicle in accordance with aspects of the inventive concepts.

FIG. 1E provides a front perspective view of a robotic vehicle in accordance with aspects of the inventive concepts.

FIG. 2 is a block diagram of components of an embodiment of the robotic vehicle of FIGS. 1A-1E, in accordance with principles of inventive concepts.

FIG. 3A is a block diagram of a method of generating a route for an AMR, in accordance with the inventive concepts.

FIG. 3B is a block diagram of a method of navigating an AMR, in accordance with the inventive concepts.

FIG. 4 is a user interface illustrating a lane grid, in accordance with aspects of the inventive concepts.

FIG. 5 is a user interface illustrating an add lane function, in accordance with aspects of the inventive concepts.

FIG. 6 is a user interface illustrating a build function, in accordance with aspects of the inventive concepts.

FIG. 7 is a user interface illustrating a training of an AMR, in accordance with aspects of the inventive concepts.

### DESCRIPTION OF PREFERRED EMBODIMENT

It will be understood that, although the terms first, second, etc. may be used herein to describe various elements, these elements should not be limited by these terms. These terms are used to distinguish one element from another, but not to imply a required sequence of elements. For example, a first element can be termed a second element, and, similarly, a second element can be termed a first element, without departing from the scope of the present invention. As used herein, the term “and/or” includes any and all combinations of one or more of the associated listed items.

It will be understood that when an element is referred to as being “on” or “connected” or “coupled” to another element, it can be directly on or connected or coupled to the other element or intervening elements may be present. In contrast, when an element is referred to as being “directly on” or “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, steps, operations, elements, and/or components, but do not preclude the presence or addition of one or more other features, steps, operations, elements, components, and/or groups thereof.

The inventive concepts relate to systems and methods that provide route generation for AMRs, which includes setting up lanes and is faster and easier for operators to complete and more flexible for load placement in operation. Loads can be pallets, carts, or any other physical entity transportable by an AMR, e.g., in a warehouse environment. The route can include a plurality of lane or route segments, each segment defining a travel path and/or a behavior at a location on a travel path. The environment can include a large number of stations, such as drop locations, pick locations, charging stations, staging areas, maintenance locations, and so forth. For a particular AMR route, a route segment can define a travel path from one station to another and the behaviors to be conducted by or with the AMR at each station, if any.

Segments can be trained between stations and can be concatenated to form the route that the AMR follows. Multiple segments can start or end at each station, so they can be combined in various ways to produce different routes. In some embodiments, a route segment is trained in a first direction and the route segment in a second direction is generated based on the training of the route segment in the first direction. As an example, a route segment trained in a first direction, e.g., from a first station to a second station, can be used to create a route segment from the second station to the first station, without having to manually drive the AMR from the second station to the first station to train the route in reverse. A segment trained, for example, from station A to station B can be used to generate a segment from B to A, without manually training the route in reverse. In some embodiments, segments trained from station A to station B and from station B to station C can be used to generate a route segment from station C to A, without manually training the route in reverse.

A lane grid is a collection of segments (along with behaviors, intersections, etc.) that can be built by a user operating a properly configured user interface (UI) device. Since, in various embodiments, all segments start and end at stations, there are stations associated with a lane grid such that full routes can visit other stations before and after passing through a lane grid. A lane grid can include segments that were trained in a first direction, but will be executed by the AMR in a second direction, without manually training the route segment in a second direction.

As an example, a lane grid can include a set of lanes where loads, e.g., pallets or carts, can be dropped within the full range of each lane instead of at a single discrete point along the lanes. Therefore, an AMR can use real-time sensor data to determine a space within a lane, from among a range of spaces within the lane, to drop the load. If a first space in a lane is determined from real-time sensor data to be obstructed, the AMR can use real-time sensor data to locate a free (unobstructed) space within the lane to drop the load. Lane grids can be added to a route and form part of the route executed by the AMR. Each lane of a lane grid can comprise or be part of at least one route segment.

Lane grids can also be generated for other areas within a route, such as intersections. In various embodiments, lane grids can be used for intersection management to optimize traffic through an intersection for more than one AMR. Lane grids can be used to allow more than one AMR to pass through the lane grid area (intersection) at a time. In such a case, the intersection can be defined as comprising a plurality of lanes and AMRs can be assigned to different lanes to safely navigate the intersection. The assignment of AMRs to specific lanes can be based on real-time sensor data and/or a supervisor system that monitors and or manages AMR traffic within an environment.

Lane grids can be generated as a logic group that can be stored and referenced as an object in a computer system, such as an AMR and/or a supervisor system. A UI that communicates with the AMR and/or supervisor system can present step-by-step user interface (UI) instructions for lane grid setup. For example, in an object-oriented programming (OOP) environment, a lane grid can be stored as a particular object that can be referenced and used for building routes. Stored lane grids can be added by reference when a route is being trained, or after a route is trained and stored and the route is being built as a combination of route segments and lane grids. The lane grid object can be an instance of a lane class. A lane grid can be a collection of lanes and/or route segments. A lane can be an area with multiple spaces that could optionally be used by an AMR. In some instances, a lane could be a linear area comprising a plurality of usable spaces. The particular space within a lane to be used by the AMR can be determined by the AMR based on real-time sensor data.

According to aspects of the present inventive concepts, the amount of duplicate travel/demonstration is drastically reduced because at least some route segments do not need to be trained in the reverse direction. Training AMRs while traveling in reverse is more difficult to demonstrate, so this approach eliminates the need to train in reverse by using forward travel over the path to generate a route segment that can be added to a route for autonomous navigation by the AMR in the reverse direction. In addition, some of the necessary behaviors are placed on the path and defined as part of a route segments automatically, rather than needing to be trained precisely in relation to other behaviors or other path or route segments. Further, connectivity of the path network and arrangement of intersections is handled automatically. Nested intersections are also created automatically, which eliminates the need to choose between the increased throughput of fine-grained intersections and the potential for deadlock without intersections.

Among other benefits, systems and methods in accordance with the inventive concepts simplify AMR route training of a complex application with many overlapping route segments. The present inventive concepts make it feasible to train large and/or complex lane staging applications efficiently.

In some embodiments, route segments can be trained in a forward direction and added to a route for AMR navigation in a reverse direction. That is, the AMRs can be driven forward (a first direction) to train route segments that the robots will drive in reverse (a second direction) in an autonomous mode. The reverse motion segment of the route network can be automatically generated as part of the training, thus, reducing the training time for the AMRs. Navigating the AMR in the forward direction makes it easier for humans to maneuver and be precise when replicating multiple lanes. Training while traveling in reverse is more difficult to demonstrate and less precise, so the inventive approach eliminates the need to train in reverse by using forward motion over the same path.

In some embodiments, the AMRs can be driven in a first direction of a route segment to train a route segment that will be driven in a second direction in autonomous mode. The second direction of the route segment can be automatically generated as part of the training, thus, reducing the training time for the AMRs.

In some embodiments, the lane grids comprise continuous lane zones, that is, a lane defines a range of linear spaces where pallets, or other loads, can be flexibly placed within lanes, instead of being placed in discrete locations for individual pallets or other loads. In some embodiments, lane grids include a plurality of such lanes. In some embodiments, two or more of the plurality of lanes may be adjacent lanes.

In some embodiments, the lane grids can be applied to intersections, e.g., to provide nested intersections. That is a lane grid can be defined as an intersection zone, with layered lanes (or route segments) so that AMRs can continue to travel along the main path as other AMRs travel within their individual lanes through the intersection. This avoids locking up the intersection and scenarios where only one AMR can access the intersection at a time.

In some embodiments, the lane grid is provided as a logic entity, that is, the lane grid is represented as a composite logic entity made of stations, route segments, zones, and other lane grid logic. This allows for the lane grid to be accessed as a whole object in the system and in the user interfaces (UIs). Lanes in a lane grid can also be individually referenced and accessible, e.g., as stored objects, for inclusion into a lane grid.

In some embodiments, the system generates a user interface that provides step-by-step instructions on a UI device for set up, storing, and editing of lane grids. In some embodiments, a set of screens can be displayed that guide users through set up of the lane grid and abstracts out technical concepts to be more user-friendly.

Aspects of the inventive concepts include:
1. Train routes in reverse: ability to drive the AMRs forward to train routes that the robots will drive in reverse in autonomous mode. This makes it easier for humans to maneuver and be precise when replicating multiple lanes.
2. Continuous lane zones: a range of linear space where pallets can be flexibly placed within lanes instead of discrete locations for individual pallets.
3. Nested intersections: layering intersection zones so that AMRs can continue to travel along the main path as other AMRs are within their individual lanes. This avoids locking up the main intersection and the scenario where only 1 AMR can access the entire buffer area at a time.
4. Lane grid as a logic entity: representing the lane grid as a composite logic entity made of stations, route segments, zones, and other lane grid logic. This allows for each buffer space or lane grid to be accessed as a whole object in the system and in the UIs.
5. Step-by-step instructions on UI for lane grid: a set of screens that guides end-users through the set up of the lane grid and abstracts out technical concepts to be more user-friendly.

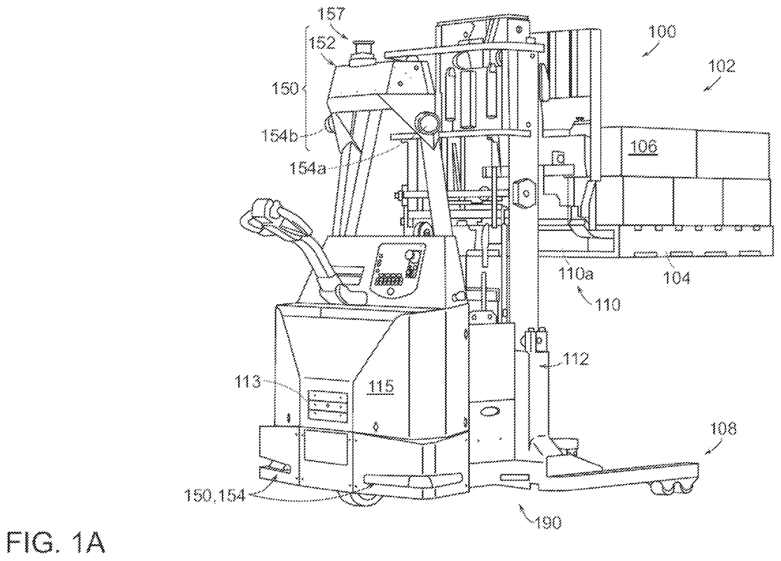

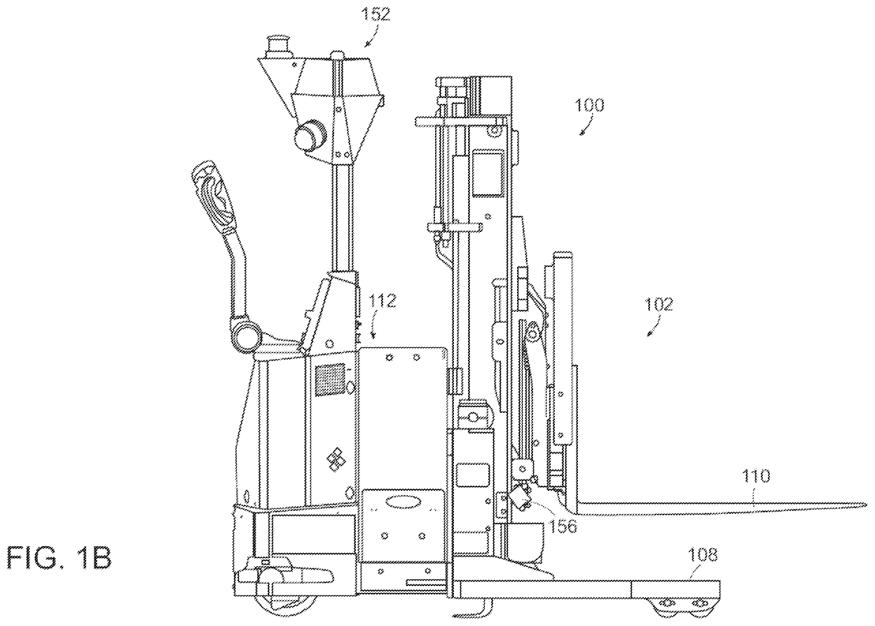

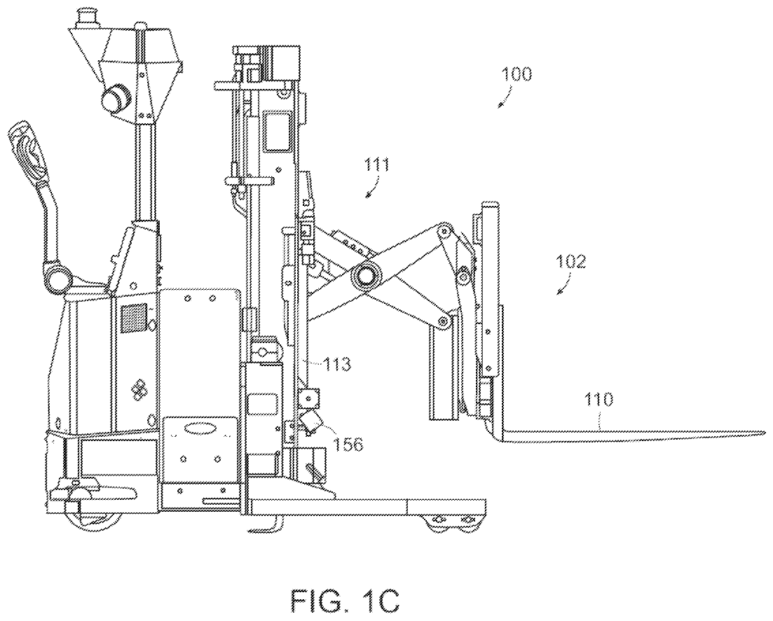

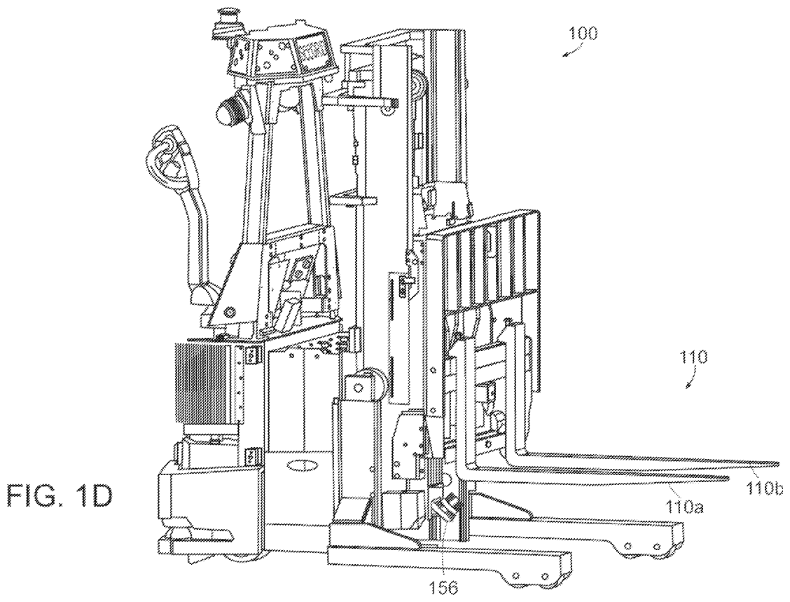

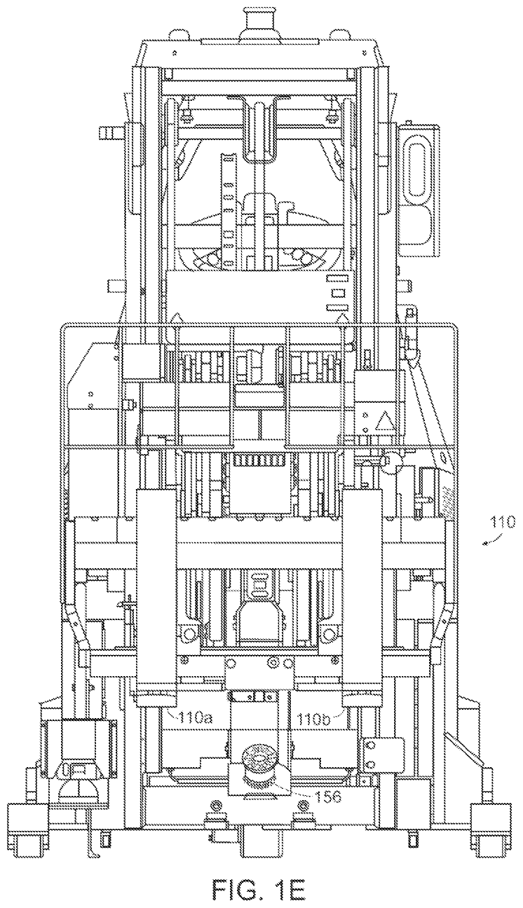

Referring to FIGS. 1A through 1E, collectively referred to as FIG. 1, shown is an example of a robotic vehicle 100 that can be configured with the sensing, processing, and memory devices and subsystems necessary and/or useful for lane grid setup, in accordance with aspects of the inventive concepts. In this embodiment, the robotic vehicle 100 takes the form of an autonomous mobile robot (AMR) pallet lift, but the inventive concepts could be embodied in any of a variety of other types of robotic vehicles and AMRs, including, but not limited to, pallet trucks, tuggers, and the like. In some embodiments, robotic vehicles described herein can employ Linux, Robot Operating System ROS2, and related libraries, which are commercially available and known in the art. But the inventive concepts are not limited to this operating system. Other operating systems could be used in other embodiments.

In this embodiment, the robotic vehicle 100 includes a payload area 102 configured to transport a pallet 104 loaded with goods, which collectively form a palletized payload 103. To engage and carry the pallet 104, the robotic vehicle may include a pair of forks 110, including a first and second forks 110a,b. Outriggers 108 extend from a chassis 190 of the robotic vehicle in the direction of the forks to stabilize the vehicle, particularly when carrying the palletized load. The robotic vehicle 100 can comprise a battery area 112 for holding one or more batteries. In various embodiments, the one or more batteries can be configured for charging via a charging interface 113. The robotic vehicle 100 can also include a main housing 115 within which various control elements and subsystems can be disposed, including those that enable the robotic vehicle to navigate from place to place.

The forks 110 may be supported by one or more robotically controlled actuators 111 coupled to a carriage 113 that enable the robotic vehicle 100 to raise and lower and extend and retract to pick up and drop off loads, e.g., palletized loads 106. In various embodiments, the robotic vehicle may be configured to robotically control the yaw, pitch, and/or roll of the forks 110 to pick a palletized load in view of the pose of the load and/or horizontal surface that supports the load. In various embodiments, the robotic vehicle may be configured to robotically control the yaw, pitch, and/or roll of the forks 110 to pick a palletized load in view of the pose of the horizontal surface that is to receive the load. The robotic vehicle also controls any translational degree of freedom, via the lift, reach, and sideshift actuators.

The robotic vehicle 100 may include a plurality of sensors 150 that provide and/or collect various forms of sensor data that enable the robotic vehicle to safely navigate throughout an environment, engage with objects to be transported, and avoid obstructions. In various embodiments, the sensor data from one or more of the sensors 150 can be used for path or route navigation and obstruction detection and avoidance, including avoidance of detected objects, hazards, humans, other robotic vehicles, and/or congestion during navigation.

One or more of the sensors 150 can form part of a two-dimensional (2D) or three-dimensional (3D) high-resolution imaging system used for navigation and/or object detection. In some embodiments, one or more of the sensors can be used to collect sensor data used to represent the environment and objects therein using point clouds to form a 3D evidence grid of the space, each point in the point cloud representing a probability of occupancy of a real-world object at that point in 3D space.

In computer vision and robotic vehicles, a typical task is to identify specific objects in an image and to determine each object's position and orientation relative to a coordinate system. This information, which is a form of sensor data, can then be used, for example, to allow a robotic vehicle to manipulate an object or to avoid moving into the object. The combination of position and orientation is referred to as the “pose” of an object. The image data from which the pose of an object is determined can be either a single image, a stereo image pair, or an image sequence where, typically, the camera as a sensor 150 is moving with a known velocity as part of the robotic vehicle.

The sensors 150 can include one or more stereo cameras 152 and/or other volumetric sensors, sonar sensors, radars, and/or laser imaging, detection, and ranging (LiDAR) scanners or sensors 154, as examples. Inventive concepts are not limited to particular types of sensors. In various embodiments, sensor data from one or more of the sensors 150, e.g., one or more stereo cameras 152 and/or LiDAR scanners 154, can be used to generate and/or update a 2-dimensional or 3-dimensional model or map of the environment, and sensor data from one or more of the sensors 150 can be used for the determining location of the robotic vehicle 100 within the environment relative to the electronic map of the environment.

In the embodiment shown in FIG. 1A, there are two LiDAR devices 154a, 154b positioned at the top of the robotic vehicle 100. In the embodiment shown in FIG. 1A, one of the LiDAR devices near the top of the robotic vehicle 154a is a 2D LiDAR device. In the embodiment shown in FIG. 1A, one of the LiDAR devices near the top of the robotic vehicle 154a is a 3D LiDAR device. In alternative embodiments, a different number of 2D LiDAR devices are positioned near the top of the robotic vehicle 100. In alternative embodiments, a different number of 3D LiDAR devices are positioned near the top of the robotic vehicle 100. In the embodiment shown in FIG. 1A, there is a sensor 157, for example, a 2D LiDAR, positioned at the top of the robotic vehicle 100 that can be used in vehicle localization.

In some embodiments, the sensors 150 can include sensors configured to detect objects in the payload area and/or behind the forks 110a,b. The sensors can be used in combination with others of the sensors, e.g., stereo camera head 152. In some embodiments, the sensors 150 can include one or more carriage sensors 156 oriented to collected 3D sensor data of the payload area 102 and/or forks 110. The carriage sensors 156 can include a 3D camera and/or a LiDAR scanner, as examples. In some embodiments, the carriage sensors 156 can be coupled to the robotic vehicle 100 so that they move in response to movement of the actuators 111 and/or fork 110. For example, in some embodiments, the carriage sensor 156 can be slidingly coupled to the carriage 113 so that the payload area sensors move in response to up and down and/or extension and retraction movement of the forks. In some embodiments, the carriage sensors collect 3D sensor data as they move with the forks.

Examples of stereo cameras arranged to provide 3-dimensional vision systems for a vehicle, which may operate at any of a variety of wavelengths, are described, for example, in U.S. Pat. No. 7,446,766, entitled Multidimensional Evidence Grids and System and Methods for Applying Same and U.S. Pat. No. 8,427,472, entitled Multi-Dimensional Evidence Grids, which are hereby incorporated by reference in their entirety. LiDAR systems arranged to provide light curtains, and their operation in vehicular applications, are described, for example, in U.S. Pat. No. 8,169,596, entitled System and Method Using a Multi-Plane Curtain, which is hereby incorporated by reference in its entirety.

In some embodiments, the sensors 150 can include sensors configured to detect objects in the payload area and/or behind the forks 110a,b. The sensors can be used in combination with others of the sensors, e.g., stereo camera head 152.

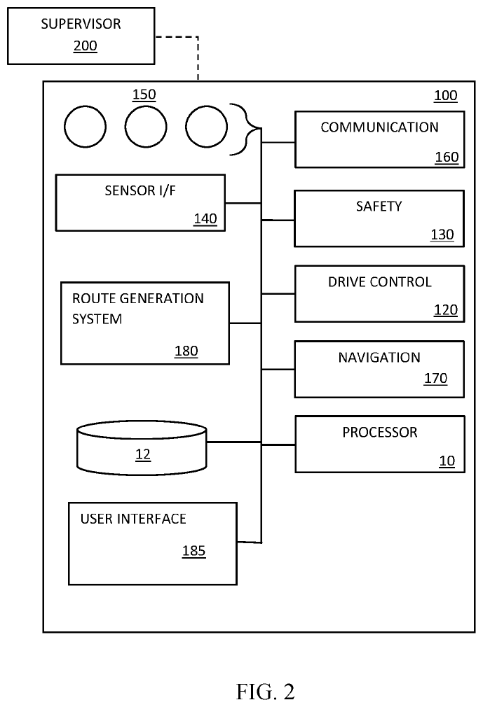

FIG. 2 is a block diagram of components of an embodiment of a system incorporating technology for generating a route for at least one AMR 100, and an example of a robotic vehicle 100, in accordance with principles of inventive concepts. Generating a route can include training the AMR and/or setting up one or more lane grids. The embodiment of FIG. 2 is an example; other embodiments of the AMR 100 can include other components and/or terminology. In the example embodiment shown in FIGS. 1 and 2, the AMR 100 is a warehouse robotic vehicle, which can interface and exchange information with one or more external systems, including a supervisor system, fleet management system, and/or warehouse management system (collectively “supervisor 200”). In various embodiments, the supervisor 200 could be configured to perform, for example, fleet management and monitoring for a plurality of vehicles (e.g., AMRs) and, optionally, other assets within the environment. The supervisor 200 can be local or remote to the environment, or some combination thereof.

In various embodiments, the supervisor 200 can be configured to provide instructions and data to the AMR 100 and/or to monitor the navigation and activity of the AMR and, optionally, other AMRs. The AMR can include a communication module 160 configured to enable communications with the supervisor 200 and/or any other external systems. The communication module 160 can include hardware, software, firmware, receivers and transmitters that enable communication with the supervisor 200 and any other internal or external systems over any now known or hereafter developed communication technology, such as various types of wireless technology including, but not limited to, WiFi, Bluetooth, cellular, global positioning system (GPS), radio frequency (RF), and so on.

As an example, the supervisor 200 could wirelessly communicate a route for the AMR 100 to navigate for the vehicle to perform a task or series of tasks, wherein such tasks can include defined behaviors to be performed at one or more locations on the AMR's route. The route can be relative to a map of the environment stored in memory and, optionally, updated from time-to-time, e.g., in real-time, from vehicle sensor data collected in real-time as the robotic vehicle 100 navigates and/or performs its tasks. The sensor data can include sensor data collected from one or more of the various sensors 150. As an example, in a warehouse setting the route could include one or more stops along a path for the picking and/or the dropping of goods. The route can include a plurality of route segments. The navigation from one stop to another can comprise one or more route segments. The supervisor 200 can also monitor the AMR 100, such as to determine AMR's location within an environment, battery status and/or fuel level, and/or other operating, vehicle, performance, and/or load parameters.

In example embodiments, a route may be developed, at least partially, by “training” the AMR 100. That is, an operator may guide and/or drive the AMR 100 through a route within the environment while the AMR, through a machine-learning process, learns and stores the route for use in task performance and builds and/or updates an electronic map of the environment as it navigates. The route may be trained as a plurality of route segments connecting stations on the planned travel path of the AMR, and defining behaviors at the stations. The route may be stored for future use and may be updated, for example, to include more, less, or different locations, or to otherwise revise the route and/or route segments, as examples. The route may include one or more pick and/or drop locations, as stations, and could include a battery charging stop, as another type of station. As will be discussed herein, to train a route, the robotic vehicle 100 may be driven in a first direction to build and/or generate a trained route segments that can be used by the robotic vehicle to navigate at least in a second direction, different from the first direction. In various embodiments, the second direction and be opposite the first direction. A user can generate lane grids from route segments; the route can be built to include a combination of the lane grids and trained route segments. In various embodiments, the robotic vehicle can execute the route to navigate in the first direction, as well as the second direction.

As is shown in FIG. 2, in example embodiments, the AMR 100 includes various functional elements, e.g., components and/or modules, which can be maintained within the housing 115. Such functional elements can include at least one processor 10 coupled to at least one memory 12 to cooperatively operate the vehicle and execute its functions or tasks. The memory 12 can include computer program instructions, e.g., in the form of a computer program product, executable by the processor 10. The memory 12 can also store various types of data and information. Such data and information can include route data, route segment data, pick data, location data, environmental data, and/or sensor data, as examples, as well as an electronic map of the environment.

In this embodiment, the processor 10 and memory 12 are shown onboard the AMR 100 of FIG. 1, but external (offboard) processors, memory, and/or computer program code could additionally or alternatively be provided. That is, in various embodiments, the processing and computer storage capabilities can be onboard, offboard, or some combination thereof. For example, some processor and/or memory functions could be distributed across the supervisor 200, other vehicles, and/or other systems external to the AMR 100.

The functional elements of the AMR 100 can further include a navigation module 170 configured to access environmental data, such as the electronic map, and route information stored in memory 12, as examples. The navigation module 170 can communicate instructions to a drive control subsystem 120 to cause the AMR 100 to navigate its route within the environment. During vehicle travel, the navigation module 170 may receive information from one or more sensors 150, via a sensor interface (I/F) 140, to control and adjust the navigation of the robotic vehicle. For example, the sensors 150 may provide 2D and/or 3D sensor data to the navigation module 170 and/or the drive control subsystem 120 in response to sensed objects and/or conditions in the environment to control and/or alter the robotic vehicle's navigation. As examples, the sensors 150 can be configured to collect sensor data related to objects, obstructions, equipment, goods to be picked, hazards, completion of a task, and/or presence of humans and/or other AMRs.

A safety module 130 can also make use of sensor data from one or more of the sensors 150, including LiDAR scanners 154, to interrupt and/or take over control of the drive control subsystem 120 in accordance with applicable safety standard and practices, such as those recommended or dictated by the United States Occupational Safety and Health Administration (OSHA) for certain safety ratings. For example, if safety sensors, e.g., sensors 154, detect objects in the path as a safety hazard, such sensor data can be used to cause the drive control subsystem 120 to stop the AMR to avoid the hazard.

The functional elements of the robotic vehicle 100 can further include a route generation system or module 180 that can include executable computer program code stored in at least one computer storage medium and executable by at least one processor to build a route for use by the robotic vehicle 100, including processing route information to determine route segments based on the manual training, formulate at least one lane grid, build a route including lane grids and route segments, and perform such other tasks that may be useful or necessary to perform and/or enable the functionality described herein or reasonably inferred from this disclosure. The built route can be stored for execution by the AMR to autonomously navigate the planned path and execute the planned behaviors at stations along the path.

The route generation system 180 can further comprise computer program code executable by at least one processor to layer intersection zones such that at least one AMR travels along a first path while at least one other AMR travels along a second path. The lane grid generation system 180 can also be configured to represent a lane grid as a logic group that can be referenced as one or more objects in the system. In various embodiments, lane segments can be created as objects, using the lane grid generation system 180. Lane grids can be generated, built, and/or configured by a user via a user interface (UI) system 185.

The UI module 185 may be configured to process human operator inputs received via a user device, e.g., a pick or drop complete input at a stop on the path. Other human inputs could also be accommodated, such as inputting map, route segments, lane grids, lanes, and/or configuration information. In various embodiments, the user interface module 185 may provide step-by-step user instructions for lane grid generation. The user interface 185 is shown onboard the AMR in FIG. 2, but in other embodiments it could be offboard or some combination of onboard and offboard. For example, some user interface module 185 functions could be distributed across the supervisor 200, other vehicles, and/or other systems external to the AMR 100, such as a handheld device, kiosk, or other computer. The UI module 185 may be used to build a route from trained route segments and lane grids, including building a route that includes one or more route segments to be navigated in a reverse of the direction it was trained. As an example, a route segment trained from station A to station B can be used to generate a segment from B to A and this latter route segment could be used to build the route for the AMR.

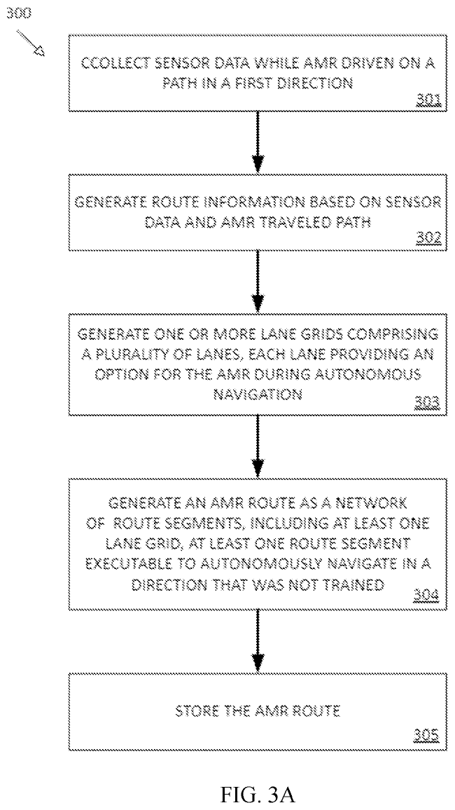

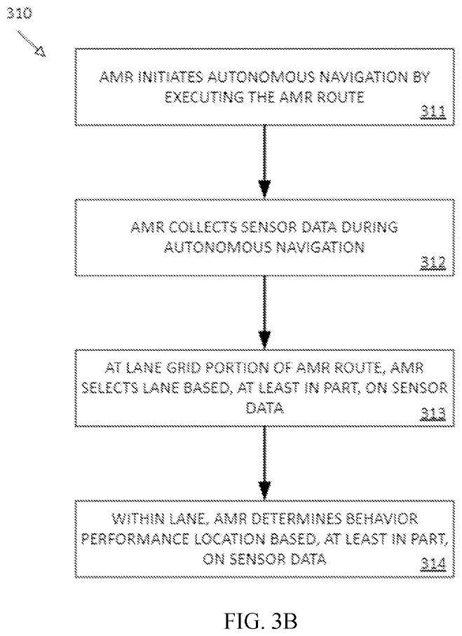

FIG. 3A is a block diagram of an embodiment of a method 300 of generating a route for navigating an AMR, in accordance with the inventive concepts. In step 301, the AMR 100 acquires or collects information from at least one sensor of an AMR while the AMR is driven in a first direction along a travel path to be subsequently autonomously executed by the AMR. In step 302, the route generation system 180 generates route information based on the sensor data and the AMR traveled path. The route information can include route segments or be used to generate route segments, each route segment being a portion of the route. In various embodiments, each route segment indicates a path to follow and/or a behavior to be performed by the AMR when executing the route segment. In various embodiments, a route segment defines navigation from one station to another station and behaviors at stations.

In step 303, the route generation system 180 generates one or more lane grids. A lane grid can comprise a plurality of lanes for use by the AMR. Each lane in the lane grid can be an option selectable by the AMR in real-time based on encountered circumstances as it autonomously navigates. Therefore, in various embodiments, the route generation system 180 generates one or more lane grids comprising a plurality of lanes, each lane providing an option for the AMR during autonomous navigation.

Lane grids can be built by a user using the user interface module 185, accessing the functionality of the route generation system 180. The UI module 403 and the route generation system 180 can cooperatively generate a set of step-by-step instructions on a UI device, such as an interactive display, that enable the user to build a lane grid. The UI device can be onboard the AMR, part of the supervisor 200, part of a handheld device or other computer terminal that can communicate with the AMR and/or supervisor 200, or some combination thereof.

In step 304, an AMR route can be generated or built as a network of route segments, incorporate one or more lane grids and route segments based on route information acquired during the training. Combining one or more lane grids with route segments based on training data can be accomplished in different ways. In one approach, during its training run the AMR can reference a lane grid object from a database that corresponds to a location of the AMR on the path. The route generation system can automatically integrate the lane grid into the route at the appropriate location during the training run. In another approach, a user operating UI module 185 can insert a lane grid, as a computer program object, into an already trained path. In various embodiments, the lane grid can be incorporated into the route as a route segment or combination of route segments after the training run is complete.

The AMR route can be built and executable by the AMR to autonomously navigate a route segment in a second direction, different from a first direction used to train the route segment. In some embodiments, the AMR can be configured to autonomously navigate the AMR route with the ability to travel in either or both of the first and second directions. For example, the AMR route can include the AMR traveling from station A to station B and then from station B back to station A.

The use of lane grids in an AMR route allows flexibility during autonomous navigation that avoids the need for high precision training of complex tasks and maneuvers—particularly in buffer zones where congestion and complexity can be most prevalent. The route generation system 180 can be used to generate lane grids that include route segments executable in a first direction even though they were trained in a second direction. That is, the route generations system allows a route segment to be added to a lane grid that causes the AMR to travel from a second station to a first station even though the route segment was trained from the first station to the second station. The route generation system 180 provides flexibility in route generation that enables significant efficiencies over prior approaches.

The lane grid can exist as an object that can be individually referenced. In various embodiments, lanes in the lane grid can be individually referenced. For example, once executing a lane grid, individual lanes within the lane grid can be recognized as different entities available for use by the AMR. In some embodiments, each lane can be defined as being within a different layer of the lane grid, and a particular layer can be referenced as a way to reference a particular lane within the lane grid. The use of layers in object-oriented programming is generally known, where a layer is a group of classes that have the same set of link-time module dependencies to other modules. The AMR can have the ability to determine which lane in a lane grid to use based on real-time sensor data, e.g., use a lane that is unobstructed and available, and/or based on information from the supervisor, another AMR, and/or some other external source.

In various embodiments, a lane can define a plurality of pick and/or drop locations. An AMR can execute the lane grid of the AMR route to provide loads within the full range of each of the plurality of lanes. Once a lane within a lane grid is selected, the AMR can determine where in the selected lane a load can be flexibly picked and/or dropped, i.e., in one of the plurality of pick and/or drop locations within the lane, based, at least in part, on real-time sensor data collected by the AMR.

Like load and drop areas, an intersection can be considered a buffer zone, potentially used by multiple entities and having an availability that is dynamically in flux. In various embodiments, the route generation system 180 can treat or model the intersection as a lane grid. In such embodiments, an individual travel path through an intersection can be considered a lane—not for picks or drops—but for travel, where lanes can be used to define individual travel paths within the intersection. The lane grid can define layers of an intersection that provide individually selectable travel path options for an AMR to travel through the intersection without collision with another AMR also traveling through the intersection. Each lane through an intersection can be part of a layer that is individually referenced by an AMR navigating the intersection. Therefore, lanes can exist in different layers of an intersection represented as a lane grid. In various embodiments, therefore, the route generation system 180 can be configured to generate a lane grid that layers intersection travel paths, e.g., as a collection of distinct lanes, such that at least one AMR can travel in a first lane (first travel path) while at least one other AMR travels in a second lane (second travel path). As a result, a plurality of AMRs can safely travel through the intersection at the same time.

In various embodiments, the method can further comprise representing the lane grid as a logic group that can be referenced as an object in the system, in accordance with principles of OOP. For example, in various embodiments, lane grids can be represented as objects in an object-oriented programming (OOP) environment.

In step 305, once the AMR route is completed, with incorporated lane grids, the AMR route can be stored for autonomous navigation use by the AMR 100.

FIG. 3B is a block diagram of a method 310 of navigating an AMR, in accordance with the inventive concepts. In step 311, the AMR 100 initiates autonomous navigation by executing an AMR route. In step 312, the AMR collects and processes real-time sensor data as it navigates. In step 313, when the AMR reaches a route segment including a lane grid, the AMR executes the lane grid to determine if a lane within the lane grid is available, e.g., unobstructed. The AMR can perform this determination based, at least in part, on real-time sensor data. The real-time sensor data can be collected by onboard sensors of the AMR. Each lane in a lane grid can be comprised of a plurality of locations where an AMR-related behavior can be performed, e.g., drop or pick a load, charge the AMR battery, etc. In step 314, once a lane in the lane grid is determined, the AMR determines a location within the lane to perform an intended behavior. As an example, the AMR can use sensor data to determine an unobstructed area within a lane to drop a pallet.

Lanes of a lane grid can be defined as layers within a lane grid object. A lane, from among a plurality of layers of the lane grid object, can be individually selectable by referencing the layer within which the lane exists.

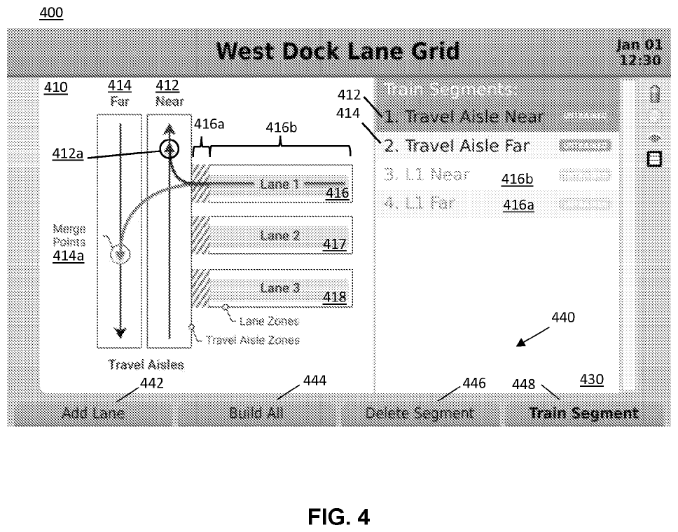

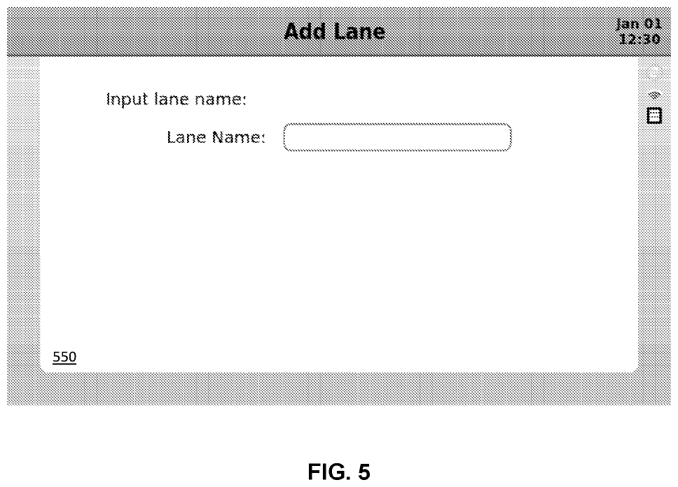

FIG. 4 is an embodiment of a user interface display illustrating an example of a lane grid, in accordance with aspects of the inventive concepts. FIG. 5 is an embodiment of a user interface illustrating training of an AMR, in accordance with aspects of the inventive concepts. The user interfaces can be generated by the user interface module 185, in communication and cooperation with the lane grid generation system 180.

FIG. 4 illustrates an embodiment of a UI 400 used for “Lane Staging”, an application in which travel aisles are adjacent to a collection of “lanes.” The lane grid being trained is referred to as the “West Dock Lane Grid.”

In FIG. 4, the Train Segment tab 448 has been selected. The Train Segment UI 400 has a plurality of panels, 410, 430. A first panel 410 graphically depicts the lanes, aisles, lane zones, aisle zones, and merge points, while panel 430 lists training segments shown in the first panel 410. The “1. Travel Aisle Near” segment is selected and highlighted.

The Train Segment tab is used to guide the human trainer through the training process. In various embodiments, segments are trained one at a time, and they may need to be trained in a particular order. The user can select an untrained segment from the list to initiate training (demonstration) of that segment.

In this example, the segments are Travel Aisle Near 412, Travel Aisle Far 414, L1 Near 416b, and L1 Far 416a. The segments L2 Near, L2 Far, L3 Near, and L3 Far could also be shown. The segments listed in the panel 430 correspond to those graphically shown in panel 410. In panel 430, for each segment there is an indication of whether or not the segment has been trained. In this example, each segment is indicated as “untrained.” These indicia will transition to “trained” once each segment is trained.

The lanes, Lane 1 416, Lane 2 417, Lane 3 418, are perpendicular to the Travel Aisles, Far 414 and Near 416, and contain regions in which an action (pick/drop) may occur. The AMR will typically enter the staging area via the aisle, reverse into a lane, perform the action (e.g., drop or pick), and then move forward to exit the lane. The AMR may visit additional lanes in the same manner prior to eventually leaving the area via the aisle.

For example, the route network pictured in FIG. 4 represents a collection of three lanes (Lane 1 416, Lane 2 417, Lane 3 418) and two Travel Aisles (Far 414, Near 412) (one in each direction). The Far travel aisle 414 of FIG. 4 is configured for an AMR to travel in a first direction. The near travel aisle 412 of FIG. 4 is configured for an AMR to travel in a second direction, opposite the first direction.

In this embodiment, the first panel 410 shows the travel direction of each Travel Aisle and merge points 414a and 412a indicating where the AMR merges with the path of the travel aisle.

In this embodiment, the UI 400 includes a plurality of tabs 440 along the bottom: Add Lane 442, Build All 444, Delete Segment 446, and Train Segment 448. The Add Lane 442 allows a user to enter the name for an additional lane (e.g., “L4”), which will become part of the lane grid, and will need to be trained. FIG. 5 is a user interface illustrating 550 an Add Lane function, in accordance with aspects of the inventive concepts.

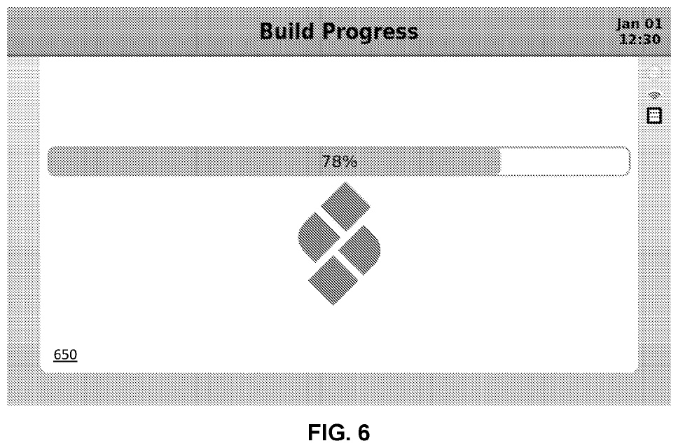

FIG. 6 is a user interface illustrating a Build function, in accordance with aspects of the inventive concepts. The Build All tab 444 transitions to a screen 650 that indicates the progress of the build progress, that is, to indicate the percentage of the build which has been completed. The Build All tab 444 is only enabled when all untrained segments have been trained and performs step 304 in FIG. 3A. That is, the Build All 444 processes the data collected during training into a representation that can be used for autonomous following.

The Delete Segment tab 446 transitions to a screen that enables a user to delete a segment from panel 410 and/or panel 430, such as lanes and travel aisles. The Delete Segment 446 allows a user to enter the name of a lane (e.g., “L4”), which will be removed from the lane grid.

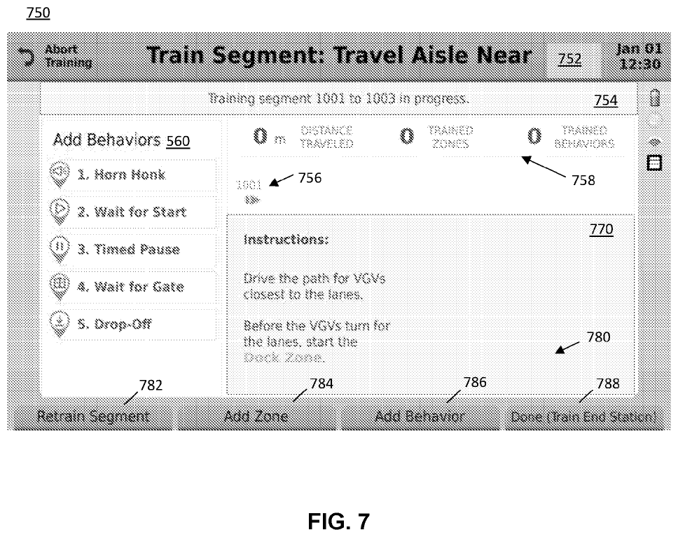

When the Train Segment tab 448 is chosen, the UI 400 transitions to a UI 750 of FIG. 7.

FIG. 7 illustrates an embodiment of user interface 750 illustrating an example of a training session in which behaviors can be added and instructions are provided for the Travel Aisle Near segment. A header area 752 of the UI 750 shows the operation being performed: Train Segment: Travel Aisle Near. Below the header 752, a banner 754 shows the segment or segments being trained, here segments 1001 to 1003. A graphical indicia 756 indicates the specific segment being trained, here segment 1001.

The UI 750 includes an Add Behaviors panel 760 that includes a list of user selectable behaviors that can be added to a segment being trained. In this embodiment, the behaviors include Honk Horn, Wait for Start, Timed Pause, Wait for Gate, and Drop-Off. In other embodiments, a different list of user-selectable behaviors could be provided.

A status area 758 shows the status of training in terms of Distance Traveled, Trained Zones, and Trained Behaviors. In this embodiment, status is shown numerically, e.g., meters (m) for Distance Traveled.

In this embodiment, and Instructions area 770 is also included. This area can be used to enter intentions and instructions for the training. For example, these instructions can be used by a user to select the behaviors from Add Behaviors panel 760.

In this embodiment, the UI 750 includes four tabs along the bottom: Retrain Segment 782, Add Zone 784, Add Behavior 786, and Done (End Train Segment) 788. The Retain Segment tab 782 can be used to transition to a new screen that enables the user to retrain an existing segment or segments. The Add Zone tab 784 can be used to transition to a new screen that enables the user to associate a zone with the segment or segments being trained. The Add Behavior tab 786 can be used to transition to a new screen that enables the user to add other behaviors, e.g., from a behavior library, beyond those listed in Add Behaviors panel 760. In some embodiments, a user can be given the opportunity to create custom behaviors. When training is complete, the Done (End Train Segment) tab 788 can be selected.

In some embodiments, aspects of the inventive concepts disclosed herein are configured to work with AMRs offered by Seegrid Corporation. The inventive concepts may be adapted for use with other AMRs as well, and are not limited to those AMRs offered by Seegrid Corporation. In some embodiments, aspects of the inventive concepts disclosed herein are configured to work with Seegrid Supervisor, for example, supervisor 200, which enables the intersection functionality. The supervisor 200 can be a separate and distinct system that interfaces with a plurality of AMRs. The supervisor 200 can take the form of a system configured to monitor, track, and/or manage a plurality of vehicles (e.g., AMRs), e.g., such as a warehouse management system. The supervisor 200 can include computer program code stored in at least one computer storage medium and executable by at least one processor to implement its functionality.

According to aspects of the inventive concepts, a system and method enable creation of a network of mobile robot route segments via demonstration of paths to follow and indication of behaviors to perform at precise positions (or ranges of positions) along these routes. The route network also contains overlapping segments and portions of segments that require spatial mutexes during execution to protect against simultaneous occupancy by multiple robots.

Spatial mutexes are a system for allowing an AMR to access a physical space with the assurance that no other AMR will have access to that space simultaneously. The mutexes are generated in the AMR on-vehicle software and the tangible output of the system is a set of intersection requests, which are sent to the supervisor 200. In various embodiments, the supervisor 200 can be configured to use these requests to manage access in a standard way. A key benefit of this system is that the mutexes are dynamically generated at follow-time based on the AMR's planned path. The system requires that the path network is constrained in particular ways and thus is restricted to specific use cases.

In accordance with aspects of the inventive concepts, the amount of duplicate travel/demonstration is drastically reduced. Training while traveling in reverse is more difficult to demonstrate, so this approach eliminates the need to train in reverse by using forward motion over the same path. Some of the necessary behaviors are placed on the path segments automatically, rather than needing to be trained precisely in relation to other behaviors or other path segments. Connectivity of the path network and arrangement of intersections is handled automatically. Nested intersections are also created automatically, which eliminates the need to choose between the increased throughput of fine-grained intersections and the potential for deadlock.

In some embodiments, open-source tools are not required. In some embodiments, the system can be implemented on a general-purpose Linux computer, using many open-source packages.

Aspects of inventive concepts disclosed herein may be applicable to general mobile robotics, especially involving training by non-expert users, as well as navigation/route-planning using a graph.

While the foregoing has described what are considered to be the best mode and/or other preferred embodiments, it is understood that various modifications may be made therein and that the invention or inventions may be implemented in various forms and embodiments, and that they may be applied in numerous applications, only some of which have been described herein. It is intended by the following claims to claim that which is literally described and all equivalents thereto, including all modifications and variations that fall within the scope of each claim.

1. A route generation system, comprising:
a computer program code stored in a computer storage media in communication with at least one processor and executable by the at least one processor to:
generate route information based on sensor data, a travel path, and a direction travelled by an AMR during a training run;
build an AMR route based on the route information, the AMR route comprising a network of route segments, including at least one route segment to be travelled in a second direction different than a first direction that the route segment was travelled during the training run; and
store the AMR route for autonomous navigation use by the AMR.

2. The system of claim 1, wherein the network of route segments comprises overlapping route segments and behaviors that execute spatial mutexes to avoid simultaneous occupancy by multiple AMRs of the overlapping route segments.

3. The system of claim 1, wherein the second direction is opposite the first direction.

4. The system of claim 1, wherein the at least one sensor includes at least one laser imaging, detection, and ranging (LiDAR) and/or at least one stereo camera.

5. The system of claim 1, wherein the system is further configured to generate the AMR route to include one or more lane grids comprising a plurality of lanes, each lane providing a selectable option for the AMR during navigation based, at least in part, on real-time sensor data collected by the AMR.

6. The system of claim 5, wherein the plurality of lanes of a lane grid includes:
at least one lane defining a plurality of pick and/or drop locations where a load can be flexibly picked and/or dropped in one of the pick and/or drop locations based, at least in part, on real-time sensor data collected by the AMR.

7. The system of claim 6, wherein the load comprises at least one pallet.

8. The system of claim 5, wherein a lane grid defines a range of adjacent lanes as linear spaces, each linear space comprising the plurality of pick and/or drop locations.

9. The system of claim 5, wherein a lane grid is generated and stored as a composite logic entity made of route segments comprising stations, routes, and/or zones.

10. The system of claim 5, wherein a lane grid is stored and individually accessible as a lane grid object.

11. The system of claim 10, wherein the lane grid object comprises a plurality of layers, each layer comprising a lane of the lane grid object.

12. The system of claim 5, wherein the system is further configured to generate a lane grid to include:
layered intersection zones having a plurality of route segments defining a plurality of travel paths through an intersection that enable the AMR to travel along a first path while at least one other AMR travels along a second path through the intersection.

13. The system of claim 12, wherein the lane grid is stored as a lane grid object that comprises a plurality of layers, each layer comprising a travel path through the intersection.

14. The system of claim 5, further comprising:
a user interface (UI) module configured to generate step-by-step user instructions via an interactive UI device that enable generation of at least one lane grid from the one or more lane grids in response to user inputs via the UI device.

15. The system of claim 14, wherein the user interface (UI) module is configured to generate one or more screens that enable a user to graphically train one or more route segments and/or lane grids.

16. The system of claim 14, wherein the user interface (UI) module is configured to generate one or more screens that enable a user to graphically train one or more route segments to be travelled in a direction different than a direction used to train the one or more route segments.

17. The system of claim 14, wherein the user interface (UI) module is configured to graphically build the AMR route as a combination of route information and/or route segments from a training run and one or more logic grids trained via the UI module.

18. The system of claim 5, further comprising:
the AMR comprising one or more sensors and a navigation system configured to autonomously navigate the AMR using the AMR route, including selectively executing a route segment from among a plurality of route segments of a lane grid based, at least in part, on real-time sensor data.

19.-35. (canceled)

36. A route generation method executable by at least one processor, the method comprising:
generating route information based on sensor data, a travel path, and a direction travelled by an AMR during a training run;
building an AMR route based on the route information, the AMR route comprising a network of route segments, including at least one route segment to be travelled in a second direction different than a first direction that the route segment was travelled during the training run; and
storing the AMR route for autonomous navigation use by the AMR.

37. The method of claim 36, wherein the network of route segments comprises overlapping route segments and behaviors that execute spatial mutexes to avoid simultaneous occupancy by multiple AMRs of the overlapping route segments.

38.-70. (canceled)

71. An autonomous mobile robot (AMR) route generation system, comprising:
at least one processor and computer memory; and
a route generation program code executable by at least one processor to:
process sensor data collected by at least one sensor while an AMR is driven in a first direction along a path;
generate route information based on the sensor data and the path;
generate one or more lane grids comprising a plurality of lanes, each lane providing a navigation option for the AMR based, at least in part, on real-time sensor data collected by the AMR; and
generate an AMR route as a network of route segments comprising at least some of the route information and the one or more lane grids, wherein the AMR route is executable by the AMR to autonomously navigate in a second direction that is different from the first direction for one or more portions of the AMR route.

72.-91. (canceled)
